(19) United States
(12) Patent Application Publication
(10) Pub. No.: US 2021/0383098 A1
(43) Pub. Date: Dec. 9, 2021

(54) FEATURE POINT EXTRACTION DEVICE, FEATURE POINT EXTRACTION METHOD, AND PROGRAM STORAGE MEDIUM

(71) Applicant: NEC Corporation, Minato-ku, Tokyo (JP)

(72) Inventor: Koichi TAKAHASHI, Tokyo (JP)

(73) Assignee: NEC Corporation, Minato-ku, Tokyo (JP)

(21) Appl. No.: 17/288,635

(22) PCT Filed: Nov. 8, 2018
(86) PCT No.: PCT/JP2018/041432

§ 371 Date: Apr. 26, 2021

(51) Int. Cl. G06K 9/00; G06K 9/32; G06T 3/40; G06K 9/20

(52) U.S. Cl. CPC G06K 9/00281; G06K 9/2054; G06T 3/40; G06K 9/3208

(57) ABSTRACT

A feature point extraction device has a following configuration to extract a feature point of an object from an image and suppress an increase in a calculation amount even in a case where an inclination of the object included in the image is large. The feature point extraction device includes a reduction unit, a first extraction unit, a correction unit, and a second extraction unit. The reduction unit reduces a data amount of an image. The first extraction unit extracts a feature point of the object included in the image from the image of which the data amount is reduced. The correction unit corrects an inclination of the object in an image before the data amount is reduced using the feature point extracted by the first extraction unit. The second extraction unit extracts a feature point of the object from the image of which the inclination is corrected.

### TECHNICAL FIELD

The present invention relates to a technology for extracting a feature point of an object from an image.

### BACKGROUND ART

A face of a person in a captured image used for face authentication is not limited to be in a setting reference state (for example, state where center line of face image, facing front side, that passes through nose bridge is along reference line extending in vertical direction defined in captured image). Therefore, for face authentication, a method for extracting a feature point of a face (hereinafter, also referred to as face feature point) is required even in a case where the face of the person in the captured image is deviated from the setting reference state, for example, in a case where the center line of the face image is inclined with respect to the reference line in the vertical direction in the captured image.

As the method for extracting the face feature point from the captured image of the face includes a method using deep learning (deep learning).

PTL 1 discloses an example of a method that does not use deep learning. In PTL 1, position coordinates of eyes are detected in face detection processing for detecting a face from a captured image. Using the detected position coordinates of the eyes, normalization processing for normalizing an inclination of the face is executed, and a face feature point is extracted from the normalized image of the face.

PTL 2 discloses a method for detecting each part of a face using the haar-like features.

### Citation List

### Patent Literature

[PTL 1] JP 2008-3749 A

[PTL 2] JP 2010-134866 A

### SUMMARY OF INVENTION

### Technical Problem

A face feature point detection method in the related art has a problem in that a calculation amount increases when a face feature point can be extracted from an image in consideration of a case where an inclination of the face in the captured image is large (a case where angle of center line of face image inclined with respect to reference line is large).

The present invention has been devised to solve the above problem. That is, a main object of the present invention is to provide a technology that can extract a feature point of an object from an image and can suppress an increase in a calculation amount for face authentication even in a case where an inclination of the object included in the image (inclination of, for example, center line set to object with respect to reference line set to image) is large.

### Solution to Problem

In order to achieve the object described above, one example embodiment of a feature point extraction device according to the present invention includes:

a reduction unit for reducing a data amount of an image;

a first extraction unit for extracting a feature point of an object included in the image from the image of which the data amount is reduced by the reduction unit;

a correction unit for correcting an inclination of the object in an image before the data amount is reduced, using the feature point extracted by the first extraction unit; and

a second extraction unit for extracting a feature point of the object from the image of which the inclination is corrected.

One example embodiment of a feature point extraction method according to the present invention performed by a computer, the method includes:

reducing a data amount of an image;

extracting a feature point of an object included in the image from the image of which the data amount is reduced;

correcting an inclination of the object in an image before the data amount is reduced using the extracted feature point; and

extracting a feature point of the object from the image of which the inclination is corrected.

Moreover, one example embodiment of a program storage medium according to the present invention for storing a computer program that causes a computer to execute:

reducing a data amount of an image;

extracting a feature point of an object included in the image from the image of which the data amount is reduced;

correcting an inclination of the object in an image before the data amount is reduced using the extracted feature point; and

extracting a feature point of the object from the image of which the inclination is corrected.

### Advantageous Effects of Invention

According to the present invention, it is possible to extract a feature point of an object from an image and suppress an increase in a calculation amount even in a case where an inclination of the object included in the image is large.

### BRIEF DESCRIPTION OF DRAWINGS

FIG. 1 is a block diagram illustrating a simplified configuration of a feature point extraction device according to a first example embodiment of the present invention.

FIG. 2 is a diagram for explaining an example of face detection processing.

FIG. 3 is a diagram for explaining an example of processing for correcting an inclination of a face in a face detection region.

FIG. 4 is a diagram for further explaining an example of the processing for correcting the inclination of the face image in the face detection region.

FIG. 5 is a flowchart illustrating an example of an operation regarding feature point extraction by the feature point extraction device according to the first example embodiment.

FIG. 6 is a block diagram illustrating a simplified configuration of an authentication device that is an example of a device using a feature point extracted by the feature point extraction device.

FIG. 7 is a block diagram illustrating a simplified configuration of an analysis device that is another example of the device using the feature point extracted by the feature point extraction device.

FIG. 8 is a block diagram illustrating a simplified configuration of a feature point extraction device according to another example embodiment of the present invention.

### EXAMPLE EMBODIMENT

Hereinafter, an example embodiment of the present invention will be described with reference to the drawings.

### First Example Embodiment

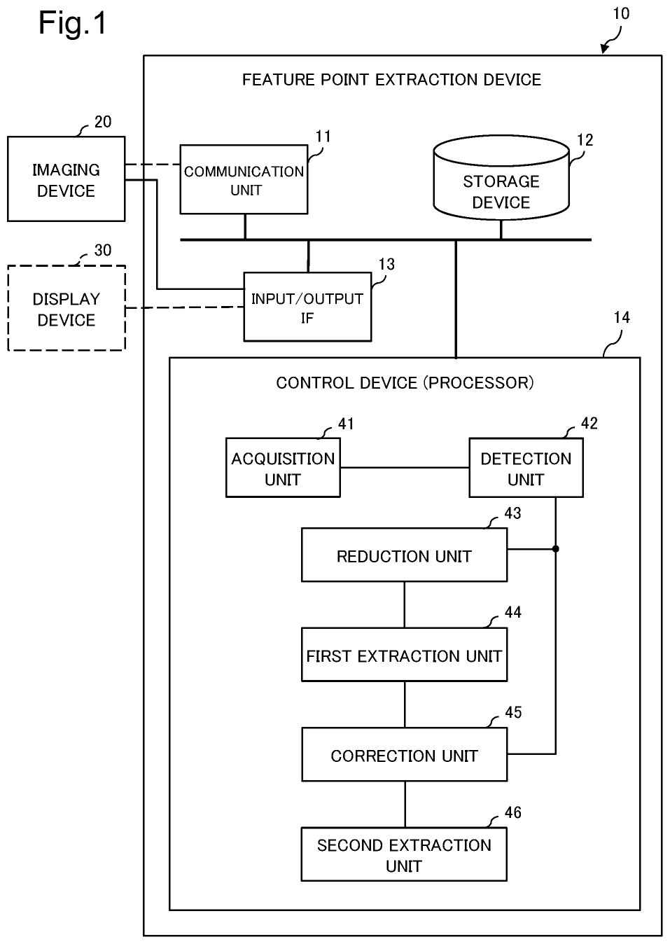

FIG. 1 is a block diagram illustrating a configuration of a feature point extraction device according to a first example embodiment together with an imaging device and a display device. A feature point extraction device 10 according to the first example embodiment is configured by a computer. The feature point extraction device 10 has a function for extracting a feature point (face feature point) of a face of a person used for face authentication of a person from a captured image. An object means a target of which a feature point is extracted. In the first example embodiment, the object of which a feature point is extracted from the captured image is a face of a person, and the feature point to be extracted is a face feature point. The face feature point is detected from a feature of the face in the image. The feature of the face is detected, for example, on the basis of a luminance difference or a luminance gradient in a pixel or a set region and determined according to the skeleton or parts of the face. The feature point indicates a position where the feature is extracted.

The feature point extraction device 10 is connected to an imaging device 20. The imaging device 20 includes, for example, a camera that captures a moving image or a still image and has a function for outputting image data of a captured image. The imaging device 20 is provided in a portable terminal device (smartphone, tablet, or the like), a notebook or fixed-type personal computer, or a gate that needs to determine whether to allow entrance so as to image a face of a person to be authenticated.

The feature point extraction device 10 includes a communication unit 11, a storage device 12, an input/output Interface (IF) 13, and a control device (processor) 14 as hardware configurations. The communication unit 11, the storage device 12, the input/output IF 13, and the control device 14 are communicably connected to each other.

The communication unit 11 has, for example, a function for achieving communication with an external device via an information communication network (not illustrated). The input/output IF 13 has a function for achieving communication of information (signal) with an external device. Examples of the external device include, for example, a display device (display) 30 that displays a video, characters, or the like and an input device (not illustrated) such as a keyboard or a touch panel to which an operator (user) of the device inputs information. The imaging device 20 is connected to the feature point extraction device 10 via the communication unit 11 or the input/output IF 13.

The storage device 12 is a storage medium that stores data and computer programs (program) and functions as a program storage medium. There are various types of storage media such as hard disks, Solid State Drives (SSDs), or the like, and the type of the storage medium included in the storage device 12 is not limited. Here, the description thereof is omitted. Although there is a case where the feature point extraction device 10 includes a plurality of types of storage media, here, these storage media are collectively indicated as the storage device 12.

The control device 14 includes a single or a plurality of processors. An example of the processor is a Central Processing Unit (CPU). The control device 14 achieves the following functional unit that controls the operation of the feature point extraction device 10 by reading a program stored in the storage device 12, writing the program in a memory in the control device 14, and executing the program.

The control device 14 achieves, as the functional units, an acquisition unit 41 that serves as acquisition means, a detection unit 42 that serves as detection means, a reduction unit 43 that serves as reduction means, a first extraction unit 44 that serves as first extraction means, a correction unit 45 that serves as correction means, and a second extraction unit 46 that serves as second extraction means.

The acquisition unit 41 has a function for acquiring the captured image imaged by the imaging device 20 via the communication unit 11 or the input/output IF 13 in a form of image data. In the first example embodiment, an image is formed by image data, and each of the functional units 41 to 46 processes the image data of the image. However, in the following description, there is a case where the image data of the image is simply referred to as an image.

The acquisition unit 41, for example, acquires the captured image transmitted from the imaging device 20 at each preset time interval. The acquisition unit 41 has a function for storing the acquired captured image in the storage device 12.

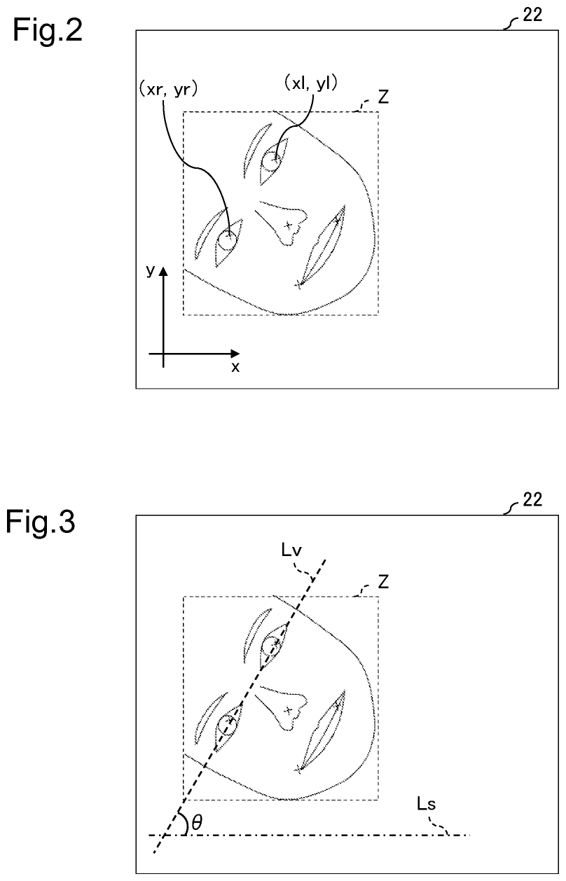

The detection unit 42 has a function for detecting a region including a face of a person (hereinafter, also referred to as face detection region) in the captured image acquired by the acquisition unit 41. For example, the detection unit 42 detects the face detection region in the captured image using reference data for face detection that has been registered in the storage device 12 in advance. As a method for detecting the face detection region using the reference data for face detection, there are various methods, for example, statistical processing using a matching result with the reference data by machine learning or the like. Here, any method may be adopted, and detailed description thereof is omitted. However, in the first example embodiment, the face detection region detected by the detection unit 42 is set as a rectangular face detection region Z having vertical and horizontal sides respectively parallel to vertical and horizontal sides of an outer shape of a rectangular captured image 22 imaged by the imaging device 20 as illustrated in FIG. 2. In the captured image, as in a case where the face detection region is not detected in a case where a part of the face is unclear because the face is oriented to the sideways or downward, there is a case where the face detection region is not detected even when the face is imaged. Moreover, a form of the reference data for face detection is a form determined according to the method for detecting the face detection region adopted by the detection unit 42.

The reduction unit 43 has a function for reducing a data amount of image data indicating an image of the face detection region Z (in other words, image including object) detected by the detection unit 42. Processing for reducing the data amount includes, for example, processing for reducing color information included in an image such as conversion of a color image into a monochrome image, processing for reducing a size of an image, processing for deteriorating a resolution, or the like. In the first example embodiment, the reduction unit 43 reduces the data amount of the image of the face detection region Z by processing including at least one of the processing for reducing the color information included in the image, the processing for reducing the image size, and the processing for deteriorating the resolution. By reducing the data amount, the number of points where features of the face (for example, luminance difference and luminance gradient) are extracted from the image of the face detection region Z is reduced. However, features of parts of the face where the features are to easily extracted are not lost.

The first extraction unit 44 has a function for extracting a feature point of the face included in the image from the image of the face detection region Z of which the data amount is reduced by the reduction unit 43. The face feature point is a point indicating a position of the feature of the face determined according to the part or the skeleton of the face as described above, and in the first example embodiment, the first extraction unit 44 extracts at least pupils as the face feature points. The face feature point extracted by the first extraction unit 44 is data used in processing executed by the correction unit 45 and is used to calculate an inclination of the face in the image of the face detection region Z. The inclination of the face here means to rotate around a front-back axis of the face along a direction from the front side of the face toward the back of the head (incline face (head) to left or right). In other words, the inclination of the face is an inclination of a virtual center line of the face passing through the bridge of the nose (in other words, center line of object) with respect to a reference line in a case where a virtual line along a vertical side of the rectangular face detection region Z as illustrated in FIG. 2 is set as the reference line. Alternatively, in a case where a virtual line along the horizontal side of the rectangular face detection region Z as illustrated in FIG. 2 is set as a reference line, the inclination of the face is an inclination of a virtual line passing through both eyes with respect to the reference line.

For example, the first extraction unit 44 extracts the face feature point from the image of the face detection region Z of which the data amount is reduced using reference data for face feature point extraction that has been registered in the storage device 12 in advance. The method for extracting the face feature point from the image of the face detection region Z using the reference data by the first extraction unit 44 is not particularly limited, and description of the method is omitted. However, the reference data for face feature point extraction used by the first extraction unit 44 is reference data in which the face feature point can be extracted from the image of the face detection region Z of which the data amount is reduced, that is, the face detection region Z including a face having a large inclination. The face having a large inclination indicates a face of which the inclination of the face as described above (inclination of virtual center line passing through bridge of nose of face with respect to reference line along vertical side of face detection region Z or inclination of virtual line passing through both eyes with respect to reference line along horizontal side of face detection region Z) is, for example, equal to or more than 45 degrees. The first extraction unit 44 may extract not only the pupils but also the top of the nose, the corners of the mouth, or the like as the face feature points.

Because the face feature point extracted by the first extraction unit 44 is data used to calculate the inclination of the face in the face detection region Z and is not data used for face authentication, extraction accuracy of the face feature point may be lower than extraction accuracy in a case where face feature points used for face authentication are extracted. In FIG. 2, an example of a position where the face feature point is extracted by the first extraction unit 44 is indicated by an x mark. In the example in FIG. 2, the extraction position of the pupil extracted by the first extraction unit 44 is deviated from the center of the pupil, and the extraction position of the left corner of the mouth of the face is deviated from the corner of the mouth. However, the deviation does not adversely affect the calculation of the inclination of the face.

The first extraction unit 44 further has a function for generating position data indicating the position of the extracted face feature point using a two-dimensional orthogonal coordinate system set to the captured image 22, for example. As a specific example, in the captured image 22 illustrated in FIG. 2, a two-dimensional orthogonal coordinate system defined by the x axis along the horizontal side and the y axis along the vertical side is set. In this case, it is assumed that coordinates indicating a position of a feature point of a left pupil be indicated as (xl, yl) and coordinates indicating a position of a feature point of a right pupil be indicated as (xr, yr). The position data represented by such coordinates is stored in, for example, the storage device 12 in association with identification information used to identify the captured image 22 from which the feature points are extracted.

The correction unit 45 has a function for correcting the inclination of the face in the image of the face detection region Z before the data amount detected by the detection unit 42 is reduced, using the face feature points extracted by the first extraction unit 44. For example, the correction unit 45 calculates an angle θ formed by a virtual line Lv that passes through the feature point of the pupil of the right eye and the feature point of the pupil of the left eye extracted by the first extraction unit 44 as illustrated in FIG. 3 and a virtual line Ls along the horizontal sides of the face detection region Z as an inclination angle of the face according to the following formula (1).

θ=arc tan ((yl−yr)/(xl−xr)) (1)

Here, yl represents the y coordinate of the feature point of the pupil of the left eye, yr represents the y coordinate of the feature point of the pupil of the right eye, xl represents the x coordinate of the feature point of the pupil of the left eye, and xr represents the x coordinate of the feature point of the pupil of the right eye.

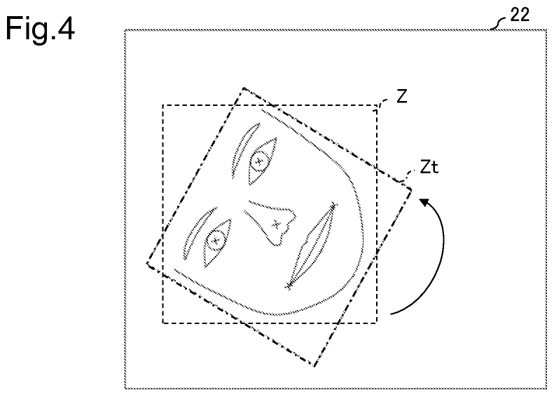

Moreover, the correction unit 45 rotates the face detection region (that is, face detection region of which data amount is not reduced) Z detected by the detection unit 42 in the captured image 22 in a direction for correcting the inclination by the calculated inclination angle θ as illustrated in FIG. 4 and sets a rotated face detection region Zt. The center of the rotation of the face detection region may be, for example, the center of the face (for example, the top of the nose) or may be the center (center of gravity) of the face detection region.

The rotation of the face detection region by the correction unit 45 causes the face relative to the face detection region Zt to be equivalent to a face in a state where the inclination is corrected. That is, the correction unit 45 can correct the inclination of the face in the face detection region in this way and can obtain the face detection region Zt including the face of which the inclination is corrected.

The second extraction unit 46 has a function for extracting a face feature point from an image (image of which data amount is not reduced) of the face detection region Zt including the face of which the inclination is corrected. The face feature point extracted by the second extraction unit 46 is a feature point to be used for face authentication, and includes, for example, the center of the pupil of the eye, the top of the nose, the left and right corners of the mouth.

The second extraction unit 46 extracts the face feature point from the image of the face detection region Zt, for example, using the reference data for face feature point extraction that has been registered in the storage device 12 in advance. A method for extracting the face feature point from the face detection region Zt using the reference data by the second extraction unit 46 is not particularly limited, and may be different from or the same as the method for extracting the face feature point by the first extraction unit 44. However, the reference data used by the second extraction unit 46 is data different from the reference data used by the first extraction unit 44. That is, the reference data used by the first extraction unit 44 is reference data in which the face feature point can be extracted from the image of the face detection region Z of which the data amount is reduced as described above, that is, the face detection region Z including the face having a large inclination. On the other hand, the second extraction unit 46 extracts a face feature point from the image of the face detection region Zt including the face of which the inclination is corrected. This indicates that the reference data used by the second extraction unit 46 is data that is generated mainly in consideration of enhancing face feature point extraction accuracy and does not need to consider that the inclination of the face is large in comparison with the first extraction unit 44. The second extraction unit 46 can extract the face feature point as indicated by the x mark in FIG. 4 with higher accuracy than the accuracy of the face feature point extraction by the first extraction unit 44 (refer to FIG. 2) since the face feature point is extracted from the image of the face detection region Zt using such reference data. Because the first extraction unit 44 and the second extraction unit 46 use the reference data as described above, the first extraction unit 44 has a wider range of the inclination of the face from which the face feature point can be extracted than the second extraction unit 46 in the face detection region.

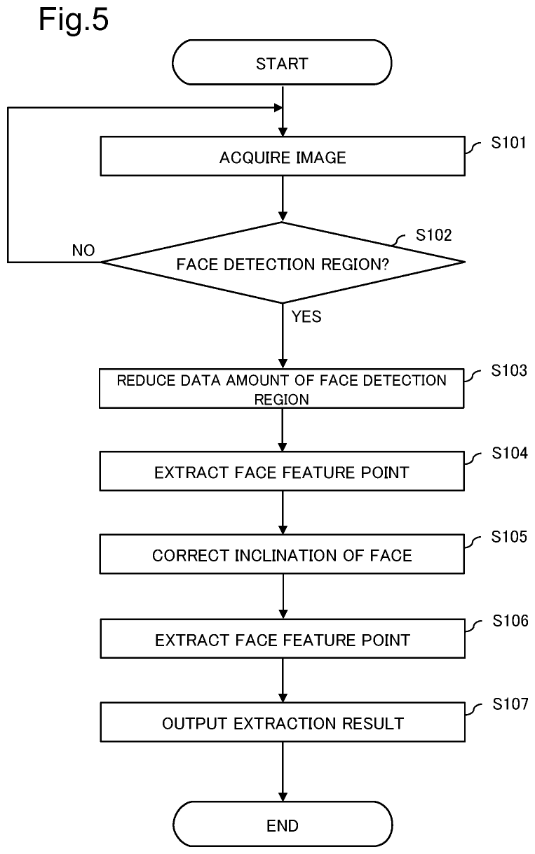

The feature point extraction device 10 according to the first example embodiment has the configuration described above. Next, an example of an operation regarding feature point extraction by the feature point extraction device 10 will be described with reference to the flowchart in FIG. 5. The flowchart in FIG. 5 illustrates a method for extracting a feature point by the feature point extraction device 10 configured by a computer.

First, when the acquisition unit 41 of the control device 14 acquires a captured image imaged by the imaging device 20 (step S101), the detection unit 42 determines whether the acquired captured image includes a face detection region (image including face of person) by the face detection processing (step S102). Then, in a case where no face detection region is included (that is, it is not possible for detection unit 42 to detect face detection region), the control device 14 prepares for acquisition of a next captured image.

On the other hand, in a case where the captured image includes the face detection region Z and the detection unit 42 can detect the face detection region Z, the reduction unit 43 executes processing for reducing a data amount of the detected face detection region Z (step S103). Then, the first extraction unit 44 extracts a face feature point from the face detection region Z of which the data amount is reduced in order to obtain a face feature point to be used by the correction unit 45 (step S104).

Thereafter, the correction unit 45 corrects an inclination of the face in the face detection region Z detected by the detection unit 42 using the face feature point extracted by the first extraction unit 44 (step S105).

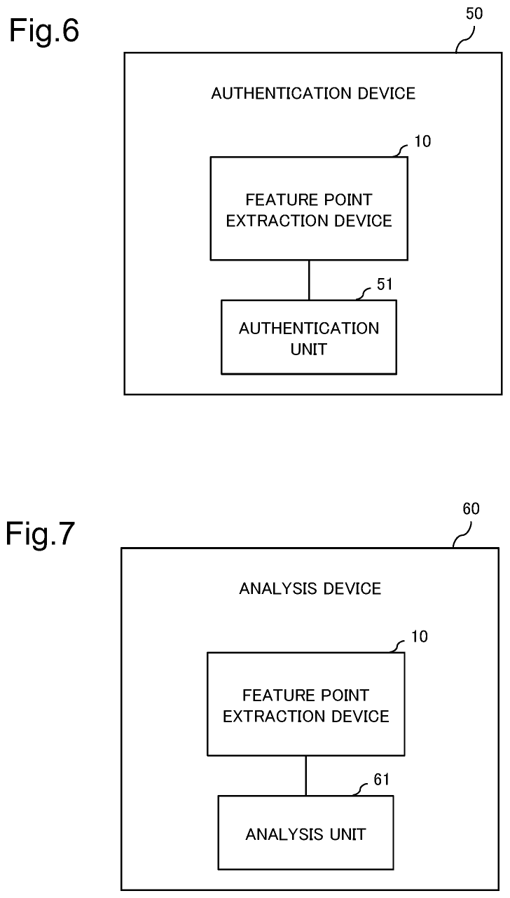

Moreover, the second extraction unit 46 extracts a face feature point used for face authentication from the face detection region Zt including the image of the face of which the inclination is corrected (step S106). Then, the second extraction unit 46 outputs data of the extracted face feature point to an output destination that has been designated in advance (step S107). For example, as illustrated in FIG. 6, in a case where the feature point extraction device 10 is incorporated in an authentication device 50, information regarding the face feature point is output to an authentication unit 51 included in the authentication device 50. The authentication unit 51 has a function for collating the data of the face feature point output from the feature point extraction device 10 with data of a face feature point of a registrant that has been registered in a storage device in advance, for example. Moreover, the authentication unit 51 has a function for determining whether to authenticate the face imaged by the imaging device 20 on the basis of the collation result. The authentication unit 51 is achieved, for example, by a CPU included in the authentication device 50. In a case where the feature point extraction device 10 is incorporated in the authentication device 50, the CPU that achieves the authentication unit 51 also functions as the control device 14 of the feature point extraction device 10.

The data of the face feature point extracted by the second extraction unit 46 may be output to a display control unit (not illustrated) that controls a display operation of a display device 30. In this case, on a display (screen) of the display device 30, the display control unit displays, for example, a position of the extracted face feature point together with the captured image.

The feature point extraction device 10 according to the first example embodiment can obtain the following effects. That is, the feature point extraction device 10 according to the first example embodiment includes the reduction unit 43 and the first extraction unit 44. Therefore, in the feature point extraction device 10, the reduction unit 43 reduces the data amount of the face detection region Z detected from the captured image, and the first extraction unit 44 extracts the face feature point for inclination correction used to correct the inclination of the image of the face from the face detection region Z of which the data amount is reduced. Accordingly, the feature point extraction device 10 can reduce a calculation amount of the processing for extracting the face feature point for inclination correction than a case where the face feature point for inclination correction is extracted from the face detection region Z without reducing the data amount.

Because the second extraction unit 46 extracts the face feature point from the face detection region Zt (that is, image of which inclination is corrected by correction unit 45 and that includes face of which data amount is not reduced), the second extraction unit 46 can extract the face feature point without deteriorating the face feature point extraction accuracy.

Therefore, the feature point extraction device 10 can extract the face feature point without deteriorating the accuracy for extracting the face feature point (feature point of object) from the captured image while suppressing an increase in the calculation amount in consideration of a case where the face of the person (object) in the captured image is inclined.

Moreover, the feature point extraction device 10 includes the detection unit 42 and has a configuration that detects the face detection region Z from the captured image by the detection unit 42 and further extracts the face feature point for inclination correction by the first extraction unit 44 from the image of the face detection region Z of which the data amount is reduced. That is, the feature point extraction device 10 extracts the face feature point for inclination correction from the image of the face detection region Z detected from the captured image, not from the entire captured image. Therefore, the feature point extraction device 10 can suppress the calculation amount of the processing for extracting the face feature point for inclination correction than a case where the face feature point for inclination correction is extracted from the entire captured image.

Moreover, the first extraction unit 44 extracts the face feature point from the image of the face detection region Z before the inclination of the face is corrected by the correction unit 45. Therefore, in the first example embodiment, the first extraction unit 44 has a configuration having a range of the inclination of the face from which the face feature point can be extracted wider than a range of the inclination of the face from which the second extraction unit 46 can extract the feature point. As a result, the feature point extraction device 10 obtains an effect that the face feature point can be extracted while suppressing the increase in the calculation amount even if the inclination of the face in the captured image 22 is large.

### Other Example Embodiment

The present invention is not limited to the first example embodiment, and various example embodiments may be adopted. For example, in the first example embodiment, the acquisition unit 41 acquires the captured image from the imaging device 20. However, for example, a configuration may be used that acquires the captured image from a storage device (not illustrated) that stores the captured image imaged by the imaging device 20.

In the first example embodiment, the feature point extraction device 10 includes the detection unit 42, the detection unit 42 detects the face detection region Z in the captured image, and the data amount of the detected face detection region Z is reduced by the reduction unit 43. Alternatively, for example, it is assumed that the processing for detecting the face detection region Z in the captured image be executed by a device different from the feature point extraction device 10 and the feature point extraction device 10 acquire the detected face detection region Z (image including object (face)). In this case, because the feature point extraction device 10 does not need to execute the processing of the detection unit 42, the detection unit 42 may be omitted.

Moreover, for example, in a case where it is assumed that the captured image be often substantially the same as the face detection region Z because a face in the captured image is large, the detection unit 42 may be omitted, and the processing for detecting the face detection region Z from the captured image may be omitted. In this case, the reduction unit 43 reduces a data amount of the entire captured image, and a correction unit 45 executes processing for rotating the captured image according to an inclination of a face.

Moreover, in the first example embodiment, the object of which a feature point is extracted is a face of a person. Alternatively, the object from which the feature point is extracted may be other than the face of the person, and for example, may be a shoulder, an elbow of the person or an object other than a human body. In such a case, the feature point to be extracted is, for example, used to analyze a movement of the object. In other words, as illustrated in FIG. 7, the feature point extraction device 10 is incorporated in an analysis device 60, and the feature point extracted by the feature point extraction device 10 may be used for analysis processing by an analysis unit 61 included in the analysis device 60. The analysis unit 61 is achieved, for example, by a CPU included in the analysis device 60. In a case where the feature point extraction device 10 is incorporated in the analysis device 60, the CPU that achieves the analysis unit 61 functions as a control device 14 of the feature point extraction device 10.

Moreover, in the first example embodiment, the face detection region Z (in other words, image including object (face)) has a rectangular shape. However, the face detection region may have a shape other than the rectangular shape. In a case where the shape of the face detection region is the shape other than the rectangular shape in this way, for example, a reference line to be a reference indicating an inclination of a face (object) with respect to a face detection region is preset on the basis of a direction of the object imaged in a reference direction that has been preset.

Moreover, the feature point extraction device 10 may have a configuration that notifies a face detection region Zt corrected by the correction unit 45 by a display device 30. Moreover, the control device 14 may include different types of processors. For example, the control device 14 may include a CPU and a Graphics Processing Unit (GPU). In this case, for example, the CPU may serve as a first extraction unit 44, and the GPU may serve as a second extraction unit 46 that has a higher calculation load than the first extraction unit 44. With this configuration, an effect is obtained that can accelerate processing for extracting a face feature point than the processing by the first example embodiment.

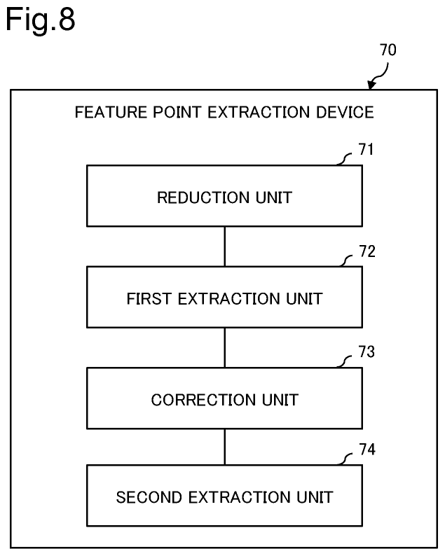

FIG. 8 is a block diagram illustrating a simplified configuration of another example embodiment of the feature point extraction device according to the present invention. A feature point extraction device 70 illustrated in FIG. 8 includes a reduction unit 71 that serves as reduction means, a first extraction unit 72 that serves as first extraction means, a correction unit 73 that serves as correction means, and a second extraction unit 74 that serves as second extraction means. The reduction unit 71 has a function for reducing a data amount of an image. The first extraction unit 72 has a function for extracting a feature point of an object included in the image of which the data amount is reduced by the reduction unit 71. The correction unit 73 has a function for correcting an inclination of the object in an image before the data amount is reduced, using the feature point extracted by the first extraction unit 72. The second extraction unit 74 has a function for extracting the feature point of the object from the image of which the inclination is corrected.

The feature point extraction device 70 in FIG. 8 obtains an effect that the feature point of the object can be extracted from the image and an increase in a calculation amount can be suppressed even in a case where the inclination of the object in the image is large.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10 feature point extraction device

12 storage device

20 imaging device

41 acquisition unit

42 detection unit

43 reduction unit

44 first extraction unit

45 correction unit

46 second extraction unit

What is claimed is:

1. A feature point extraction device comprising:
at least one processor configured to:
reduce a data amount of an image;
extract a first feature point of an object included in the image from the image of which the data amount is reduced;
correct an inclination of the object in an image before the data amount is reduced, using the first feature point; and
extract a second feature point of the object from the image of which the inclination is corrected.

2. The feature point extraction device according to claim 1, wherein
the at least one processor is further configured to:
detect a region of an image including the object in a captured image imaged by an imaging device, wherein
the at least one processor reduces a data amount of the detected region in the captured image.

3. The feature point extraction device according to claim 1, wherein a range of an inclination of the object from which the first feature point can be extracted is wider than a range of an inclination of the object from which the second feature point can be extracted.

4. The feature point extraction device according to claim 1, wherein the at least one processor reduces the data amount of the image by processing including at least one of processing for reducing color information included in the image, processing for reducing an image size, and processing for deteriorating a resolution.

5. The feature point extraction device according to claim 1, wherein the object is a face of a person.

6. A feature point extraction method performed by a computer, the method comprising:
reducing a data amount of an image;
extracting a first feature point of an object included in the image from the image of which the data amount is reduced;
correcting an inclination of the object in an image before the data amount is reduced using the extracted first feature point; and
extracting a second feature point of the object from the image of which the inclination is corrected.

7. A non-transitory program storage medium for storing a computer program that causes a computer to execute:
reducing a data amount of an image;
extracting a first feature point of an object included in the image from the image of which the data amount is reduced;
correcting an inclination of the object in an image before the data amount is reduced using the extracted first feature point; and
extracting a second feature point of the object from the image of which the inclination is corrected.
